(19) United States
(12) Patent Application Publication
(10) Pub. No.: US 2016/0003331 A1
(43) Pub. Date: Jan. 7, 2016

(54) MOTOR VEHICLE DOOR CLOSURE

(71) Applicant: KIEKERT AKTIENGESELLSCHAFT, Heiligenhaus (DE)

(72) Inventors: Claus Topfer, Sindelfingen, Rhineland-Palatinate (DE); Uwe Reddmann, Essen, North Rhine-Westphalia (DE); Michael Scholz, Essen, North Rhine-Westphalia (DE); Christian Sturm, Krefeld, North Rhine-Westphalia (DE)

(21) Appl. No.: 14/768,495

(22) PCT Filed: Feb. 27, 2014
(86) PCT No.: PCT/DE2014/000079

§ 371 Date: Sep. 18, 2015

(30) Foreign Application Priority Data
Mar. 1, 2013 (DE) 10 2013 102 063.1
Jun. 26, 2013 (DE) 10 2013 106 672.0

(51) Int. Cl. F16H 25/14; E05C 21/00; B60J 5/00

(52) U.S. Cl. CPC F16H 25/14; B60J 5/00; E05C 21/00

(57) ABSTRACT

The invention relates to a motor vehicle door closure which is equipped with a pulling-shut/opening device with a drive and transmission element. In addition, a locking mechanism is realized. The drive operates, with the interconnection of the transmission element, on the locking mechanism in order to open the latter or pull the latter shut. According to the invention, the drive is designed to have a variable torque and act upon the transmission element with a torque which is dependent on the drive travel.

### CROSS-REFERENCE TO RELATED APPLICATIONS

This application is the U.S. national stage application of International Patent Application No. PCT/DE2014/000079, filed Feb. 27, 2014, which claims priority of German Application No. 10 2013 102 063.1, filed Mar. 1, 2013; and German Application No. 10 2013 106 672.0, filed Jun. 26, 2013, which are hereby incorporated by reference.

### BACKGROUND

The invention relates to a motor vehicle door closure which is equipped with a closing/opening device containing a drive, a transmission element and a locking mechanism, with the drive acting on the locking mechanism with the aid of the transmission element in order to close or open it.

A variety of designs are known for motor vehicle door closures. DE 101 40 385 A1 discloses a servo latch holder for a motor vehicle door closure in which a locking bolt of the motor vehicle door closure is mounted on an adjustable actuation rocker arm. A drive for the actuation rocker arm is also provided. The drive moves the actuation rocker arm with the locking bolt and a catch surrounding the locking bolt and thus an associated door, out of a preliminary closed position into a fully closed position with the aid of a motor. An additional blocking lever ensures that the actuation rocker arm is held in this position when the door is manually moved from the preliminary closed position to the fully closed position.

Such servo latch holders are generally used in all doors of a motor vehicle. In this way, not only side doors but also boot lids and tailgate flaps or even bonnets can be acted upon and are covered by the invention. By means of the closing aid provided in this way or the servo latch holder, the respective door or vehicle door can be moved from said preliminary closed position into a fully closed position against the resistance of, for instance, a door seal. As a result, the door can be closed with little noise and with little force.

Another design of a closing device is disclosed in DE 198 28 040 B4, describing a power-assisted closing device for doors, flaps, hoods or roofs of vehicles and, in particular, cars in which a pivotable fixing element is arranged on a catch. The pawl interacting with the catch also has a pivotable fixing element. The two fixing elements cooperate with a control disk during the opening and closing process. The control disk is part of an actuating drive with the aid of which an opening and closing operation can be carried out.

The described drives and the associated elements are often relatively large so that the drive is generally positioned remotely from the locking mechanism and thus from an associated motor vehicle door or is installed in the car body. Movements of the electric drive are in this case transmitted to the locking mechanism by means of the transmission element. The transmission element is typically a Bowden cable, although also rods, pulleys, etc. can be advantageously used at this point.

According to the generic state of the art disclosed in DE 20 2008 015 789 U1, a transmission lever is provided that is positioned on the same axis as that of a catch of the locking mechanism. A drive pawl is also mounted on a transmission element. The drive pawl is connected to the drive by means of a Bowden cable or another connection means.

The known closing/opening devices of motor vehicle doors are generally used successfully but are, however, often limited in practical application and require improvement. This is mainly due to the fact that the force transmitted from the drive onto the locking mechanism via the transmission element during closing of the respective door, is not even along the drive travel. Or in other words, the motor vehicle door opposes the drive with different forces along the drive travel during closing.

This is, in particular, due to the fact that a seal closing the motor vehicle door must be increasingly compressed towards the end of the drive travel or of the closing travel. This means that the closing force exerted by the drive onto the locking mechanism via the transmission element increases or decreases depending on the drive travel. This means that in practical application relatively large, heavy and expensive drives are used in order to ensure that the closing movement can be implemented. Such a design is disadvantageous for weight and cost reasons. This is remedied by the invention.

### SUMMARY

The invention is based on the technical problem of further developing such a motor vehicle door closure in such a way that an optimized drive is provided that is lower in weight and cost but provides the same functionality.

In order to solve this technical problem, a generic motor vehicle door closure of the invention is characterized by the drive being designed to have a variable torque and act on the transmission element with a torque depending on the drive travel and thus a force depending on this drive travel.

According to an advantageous embodiment, the drive contains a torque converter. This torque converter is generally designed in such a way that with an increasing drive travel a progressively rising torque is provided on the output side. Alternatively, the torque converter can, however, also provide a degressively decreasing torque or a degressively decreasing force on the output side as the drive travel increases. The invention can also operate with a linearly increasing torque as the drive travel increases and a respectively linearly increasing force on the output side.

The torque on the output side or the respective force is in any case used to act on the transmission element. The said different designs (progressive, degressive, linear) can be advantageously achieved by the torque converter being interchangeable.

In the event that a closing device is provided, the drive travel corresponds to a closing travel. This closing travel generally starts in a preliminary closed position of the locking mechanism. The reaching of this preliminary closed position generally corresponds to the drive of the closing device being started and ensuring that the locking mechanism is moved from its preliminary closed position into its fully closed position. Consequently, the increasing closing travel is also part of the transition from the preliminary closed position into the fully closed position in the described example.—A potential alternative opening device will operate the other way around

As part of the drive, the torque converter will ensure in any case that as the drive travel or the closing travel increases in a closing device and thus during the transition from the preliminary closed position to the fully closed position, as in the described above example, the torque provided by the torque converter and thus the force or closing force increases progressively. As a result, the locking mechanism is also pulled closed as the force increases, so that any increasing counter forces produced by a compression of the door rubber seal, can be overcome.

This is achieved at this point with a relatively small and low-cost drive or a respectively designed electric motor, saving both weight and cost. The torque converter used by the invention is actually able to provide a power transmission of up to 4:1. This means that the power provided by the electric motor on the output side can be progressively increased by up to a factor of four along the drive travel or closing travel by the described torque conversion. These are the main advantages.

A torque converter can in general consist of any conceivable gear arrangement and can be implemented according to the invention, such as a planetary or helical gear. It is, however, particularly advantageous for the torque converter to be a cam disc connected to the drive. Such a cam disk offers the advantage of a low weight and a simple design, resulting in significantly reduced costs and weight despite of the additional torque converter. Such a cam disk can also be easily replaced, ensuring that the torque converter as a whole is interchangeable. In this case, the drive as a whole is designed in a manner of a drive kit, i.e. the cam discs connected to the drive can be selected and used depending on the desired torque curve.

The respective cam disc is typically driven with the aid of a screw connected to the drive shaft of the motor. As part of this process, the screw engages with a gear on the circumference of the cam disc. The cam disc advantageously contains a spiral control contour. The radius of the control contour increasing due to the spiral shape is designed in such a way that it increases from the centre of the cam disc in the direction of the circumference of the disc.

One end of the transmission element is in turn connected to the cam disc or the control contour. The other end of the transmission element acts, on the other hand, on the locking mechanism. This arrangement can be particularly advantageously and simply used where the transmission element is a Bowden cable.

Such a Bowden cable typically consists of a central core and a sleeve surrounding the core. Both ends of the sleeve are generally supported by the respective bearings. As a result, the core can transfer forces compared to the sleeve. According to the invention, the core is connected to the cam disc or is connected to the control contour formed on the cam disc. As the control contour contains a spiral radius increasing from the centre point, a torque increasing with the radius of the spiral control contour is exerted on the end of the transmission element connected to the cam disc or the core of the Bowden cable during a rotation of the cam disc. This increasing torque on the input side of the transmission element or of the Bowden cable corresponds on the output side to a respective progressively increasing force or closing force, with the aid of which the catch is, for instance, moved from its preliminary closed position into the fully closed position.

For this purpose, the end of the transmission element connected to the locking mechanism or the Bowden cable can act on a transmission lever, which in turn acts on the catch in a closing sense via a drive pawl, similarly as disclosed in the aforementioned DE 20 2008 015 789 U1. Alternatively, also the locking mechanism end of the transmission element or of the Bowden cable can act directly on the catch in order to close it in the described manner, i.e. to move it in the example from the preliminary closed position into the fully closed position.

In a particularly preferred embodiment, the torque converter is interchangeable. If it is the already discussed cam disc with the control contour, the design is such that the control contour is connected to the cam disc via a plug-in connection or a similar detachable connection. As a result the control contour can be easily adapted to the actual conditions in the respective motor vehicle door closure, depending on the design and the required force.

Also significant is the fact that the drive contains or can contain a spring mechanism. This spring mechanism can, for instance, be used to assist the closing movement. This is made possible by the fact that the drive charges the spring mechanism energetically during a reset movement and that the energy from the spring mechanism stored in this way is then also available during a working movement and supports the effect of the torque converter. The spring mechanism is advantageously a simple and cost effective leg spring, although this is not mandatory.

The object of the invention is also to provide a method for closing and opening a locking mechanism of a motor vehicle door latch, as explained in detail in claim 10. Below, the invention is explained in detail with reference to a drawing showing only one embodiment, in which:

### BRIEF DESCRIPTION OF THE DRAWINGS

FIGS. 1A and 1B show the motor vehicle door closure of the invention, reduced to the components essential for the invention and in different functional positions,

FIGS. 2A and 2B show a version of the motor vehicle door closure corresponding to FIGS. 1A and 1B and

FIG. 3 shows a view of the locking mechanism of the motor vehicle door closure

### DETAILED DESCRIPTION OF THE DRAWINGS

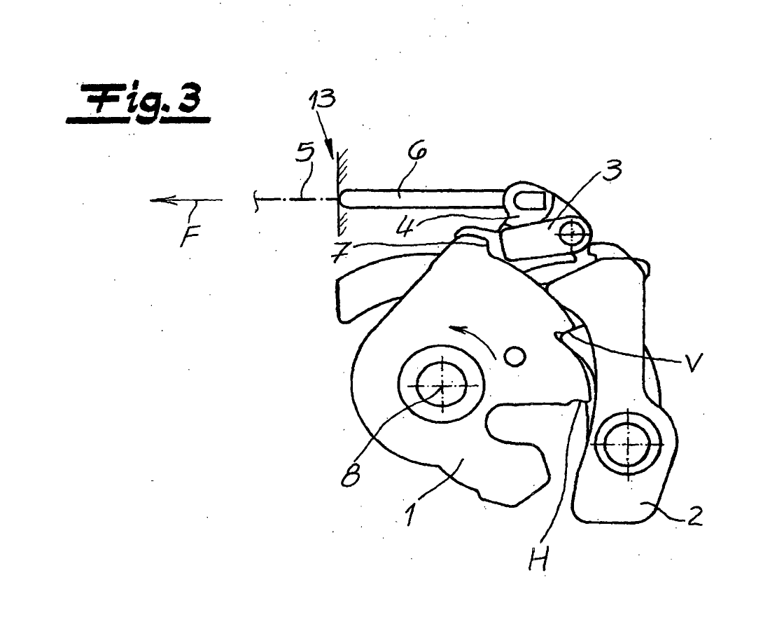

The figures show a motor vehicle door latch containing a usual locking mechanism 1, 2 comprising a catch 1 and a pawl 2. The locking mechanism 1, 2 is only shown in FIG. 3. This figure also shows a closing pawl 3, acted upon by a Bowden cable 5, 6 in connection with a transmission lever 4. In the embodiment, the Bowden cable 5, 6 is a transmission element 5, 6.

As soon as a closing force F acts on the Bowden cable 5, 6 or its core 5 in comparison to the sleeve 6 in a left direction in FIG. 3, a drive pawl 3 moving against a stop 7 on the catch 1 ensures that the catch 1 is moved from its preliminary closed position shown in FIG. 3 into a fully closed position. For this purpose, the catch 1 must pivot around its axis of rotation in the indicated counterclockwise direction.

The preliminary closed position shown FIG. 3 corresponds to the pawl 2 interacting with a preliminary closed contour V of the catch 1. Once the transmission element 5, 6 or the Bowden cable 5, 6 is acted upon by the force F shown in FIG. 3 in the left direction, this force ensures that with the aid of the transmission lever 4, the drive pawl 3 and the stop 7 pivot the catch 1 in counterclockwise direction. As a result, the pawl 2 cooperates with a main latch contour H at the end of described closing movement. The locking mechanism 1, 2 is consequently moved from the preliminary closed position into the fully closed position.

In order to be able to implement the closing movements described in FIG. 3, the example embodiment contains a closing device 5, 6; 9, 10, 11. The closing device 5, 6; 9, 10, 11 consists of the transmission element 5, 6 or Bowden cable 5, 6, already described in FIG. 3 and a drive 9, 10, 11 described in detail below. The drive 9, 10, 11 acts on the locking mechanism 1, 2 by means of the transmission element 5, 6, ensuring in the example, that the locking mechanism 1, 2 or its catch 1 is moved from the preliminary closed position into the fully closed position, as described.

For this purpose, a sensor regularly checks whether the locking mechanism 1, 2 is in the preliminary closed position. As soon as the locking mechanisms 1, 2 has entered the preliminary closed position as a result of a respective motor vehicle door being closed, an electric motor 9 is energized as part of the drive 9, 10, 11.

The electric motor 9 acts on a torque converter 10, 11, which in turn acts on the transmission element 5, 6 for closing the locking mechanism 1, 2. In principle, the arrangement could also contain a reverse-acting opening device at this point, which is, however, not shown.

The drive 9, 10, 11 as such is designed for a variable torque. In this way the drive 9, 10, 11 acts on the transmission element 5, 6 with a torque depending on the drive travel s. As a result, the force or closing force F acting on the transmission element 5, 6 changes depending on the drive travel s. The drive travel s is indicated in the figures by a main arrow and is designed to have the same direction as the force or closing force F acting on the locking mechanism 1, 2.

In the example, the start of the drive travel s corresponds to the locking mechanism 1, 2 assuming the preliminary closed position shown in FIG. 3, although the invention is not limited to this. The end of the drive travel or of the closing travel s is associated with the locking mechanism 1, 2 having been moved into the fully closed position.

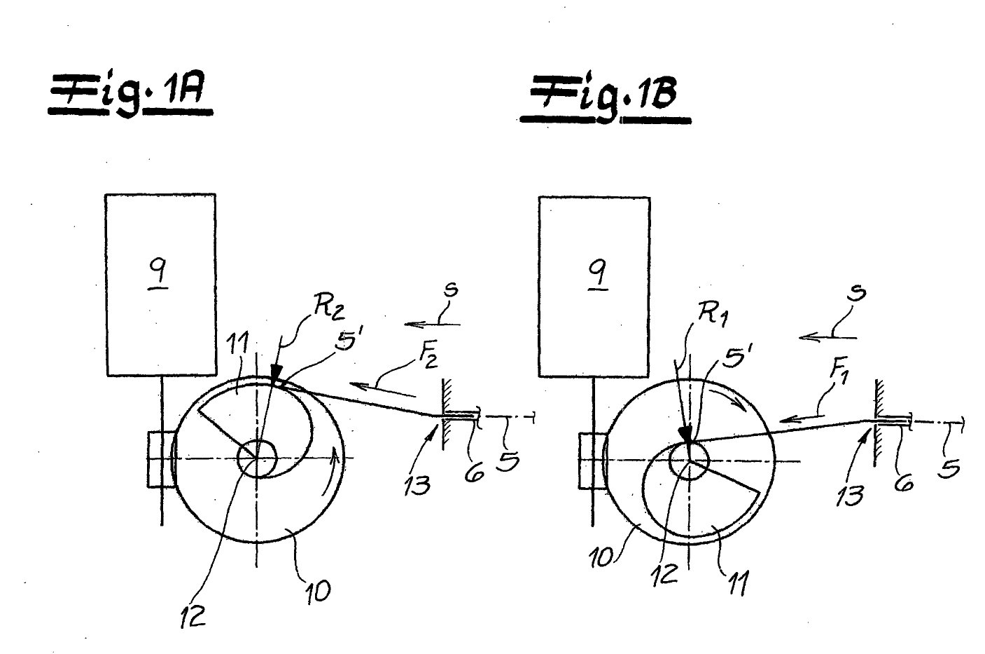

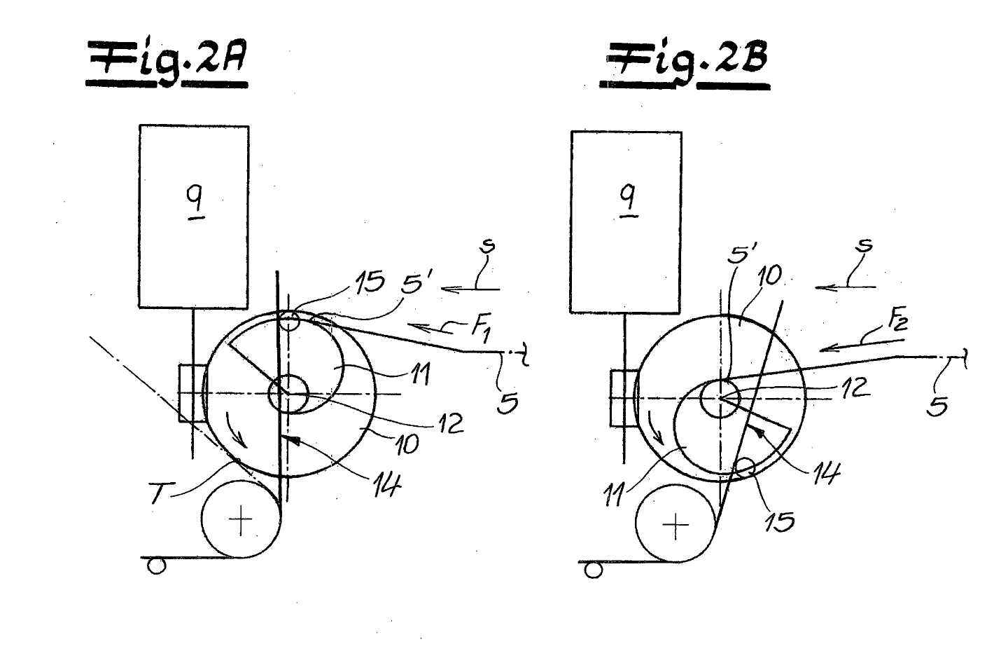

As part of this invention, a torque depending on drive travel s, acts on the transmission element 5, 6. For this purpose, the drive 9, 10, 11 contains the already mentioned torque converter 10, 11. As the drive travel s increases, the torque converter 10, 11 provides a progressively increasing torque, as apparent when comparing FIGS. 1A and 1B or 2A and 2B. As a result, the force F progressively increases with the increasing drive travel s.

This increasing torque manifests itself in the circumstance that the end 5′ of the transmission element 5, 6 connected to the torque converter 10, 11 or of the core 5 of the Bowden cable 5, 6 forms a (small) radius R1 with an axis or a rotation axis 12 of a cam disc 10 at the start of the drive travel or of the closing travel s, as shown in FIG. 1B. In this case, a low torque and thus also a low force F1 acts on the core 5 of the Bowden cable 5, 6. As the sleeve 6 of the Bowden cable 5, 6 rests on bearings 13 on both sides, the locking mechanism 1, 2 or the catch 1 can be acted upon with the respective closing force F₁ as described.

In contrast, the end of the drive travel or of the closing travel s contains a radius R₂, as apparent from FIG. 1A. This corresponds to a high torque and thus also an increased force F₂ at the end of the drive travel or closing travel s, in the embodiment, shortly before the locking mechanism 1, 2 reaches the fully closed position. With the aid of this increased force F₂ any counter forces such as, for instance, rubber door seals, can be overcome.

The torque converter 10, 11 comprises the aforementioned cam disc 10 and a spiral control contour 11. The cam disc 10 is rotated by the electric motor 9. A counterclockwise movement of the cam disc 10 corresponds to the closing operation, i.e. a working movement of the drive 9, 10, 11. If the electric motor 9 does, however, act on the cam disc 10 in clockwise direction, this corresponds to a resetting movement of the drive 9, 10, 11.

The spiral control contour 11 contains a radius R increasing from the centre of the cam disc 10 or from the axis of rotation 12 towards the circumference of the cam disc 10, as shown in the figures, from an actual value R₁ to R₂. As a result of this spiral design of the control contour 11 the aforementioned different radii R₁ to R₂ are produced, depending on the position of the control contour 11 in relation to the end 5′ of the transmission element 5, 6. This results in the different torques along the drive travel or closing travel s and the respective forces F₁, F₂.

In order to be able to work with different torque converters 10, 11 in this way, the torque converter 10, 11 is interchangeable. The control contour 11 can contain a plug-in connection—not shown—or a comparable detachable connection with the cam disc 10. In general, the cam disc 10 can, however, also be designed to be interchangeable. As a result, not only the described torque progressions but also a torque linearly increasing with the closing travel s, can be achieved. Also a degressive or decreasing torque can be provided with an increasing closing travel s.

In the option shown in FIGS. 2A and 2B, the drive 9, 10, 11 also contains a spring mechanism 14. The spring mechanism 14 is mainly a leg spring 14. One leg of the leg spring 14 rests against a journal 15 arranged on or at the cam disc 10. In the example, the spring mechanism 14 can thus be loaded in counterclockwise direction, so that the working movement is assisted by the respectively stored spring force being released. In this context, the leg spring 14 is pretensioned by means of a long lever arm, so that the spring mechanism 14 can assist the closing of the drive 9, 10, 11 when beyond a dead centre T. In this way, the provided closing force F can be increased.

In the option shown in FIGS. 2A and 2B, the resetting movement and the working movement of the drive 9, 10, 11 follow the same direction and correspond to a clockwise rotation of the cam disc 10. During this process, the locking mechanism 1, 2 is initially acted on again with the low force F₁. Only at the end of the working movement and thus of the closing travel s is the increased force F₂ available. Beyond the dead centre T this is ensured by the spring mechanism 14, providing the additional force as it is released.

1. Motor vehicle door closure equipped with a closing/opening device containing a drive and a transmission element, and a locking mechanism, in which the drive acts on the locking mechanism with the aid of the transmission element in order to close or open it, characterized in that the drive is designed to have a variable torque and act upon the transmission element with a torque that is dependent on the drive travel and thus also with a force depending on the drive travel.

2. Motor vehicle door closure according to claim 1, characterized in that the drive contains a preferably interchangeable torque converter, generating a progressively or linearly increasing torque or a progressively or linearly increasing force or a degressively decreasing torque or a degressively decreasing force as the drive travel increases.

3. Motor vehicle door closure according to claim 1, characterized in that the converter contains a cam disc connected to an electric motor.

4. Motor vehicle door closure according to claim 3, characterized in that one end of the transmission element is connected to the cam disc, whilst the other end acts on the locking mechanism.

5. Motor vehicle door closure according to claim 3, characterized in that the cam disc has a spiral-shaped control contour whose radius increases from a centre in the direction of the circumference of the cam disc.

6. Motor vehicle door closure according to claim 2, characterized in that the torque converter is designed to be interchangeable.

7. Motor vehicle door closure according to claim 5, characterized in that the control contour is connected to the cam disc by a plug-in connection or a similar detachable connection.

8. Motor vehicle door closure according to claim 1, characterized in that the drive contains a spring mechanism.

9. Motor vehicle door closure according to claim 1, characterized in that the transmission element is designed as a Bowden cable.

10. Method for closing or opening a locking mechanism in a motor vehicle door closure, in which a drive acts on the locking mechanism by means of an interposed transmission element in order to close or open it, characterized in that the drive is designed to have a variable torque and acts on the transmission element with a torque depending on the drive travel and thus also a force depending on the drive travel.

11. Motor vehicle door closure according to claim 1, characterized in that the drive contains a torque converter generating a progressively increasing torque as the drive travel increases.

12. Motor vehicle door closure according to claim 11, characterized in that the converter contains a cam disc connected to an electric motor.

13. Motor vehicle door closure according to claim 12, characterized in that one end of the transmission element is connected to the cam disc, whilst the other end acts on the locking mechanism.

14. Motor vehicle door closure according to claim 13, characterized in that the cam disc has a spiral-shaped control contour whose radius increases from a centre in the direction of the circumference of the cam disc.

15. Motor vehicle door closure according to claim 14, characterized in that the torque converter is designed to be interchangeable.

16. Motor vehicle door closure according to claim 15, characterized in that the control contour is connected to the cam disc by a detachable connection.

17. Motor vehicle door closure according to claim 16, characterized in that the drive contains a spring mechanism.

18. Motor vehicle door closure according to claim 1, characterized in that the contains a torque converter generating a degressively decreasing torque as the drive travel increases.

19. Motor vehicle door closure according to claim 18, characterized in that the cam disc has a spiral-shaped control contour whose radius increases from a centre in the direction of the circumference of the cam disc.

20. Motor vehicle door closure according to claim 19, characterized in that the control contour is connected to the cam disc by a detachable connection.
